(19) United States
(12) Patent Application Publication
(10) Pub. No.: US 2007/0246326 A1
(43) Pub. Date: Oct. 25, 2007

(54) FLAVOR STRIP RETAINING BOARD FOR VENDING MACHINE SIGNFRONT

(76) Inventors: William L. Roberson, Springfield, SC (US); Richard L. Greenfield, Barnwell, SC (US); Daniel J. Bowen, Aiken, SC (US)

Correspondence Address: MCANDREWS HELD & MALLOY, LTD, 500 WEST MADISON STREET, SUITE 3400, CHICAGO, IL, 60661, US

(21) Appl. No.: 11/697,104

(22) Filed: Apr. 5, 2007

Related U.S. Application Data
(60) Provisional application No. 60/789,674, filed on Apr. 5, 2006.

(51) Int. Cl. G07F 9/10

(52) U.S. Cl. 194/350

(57) ABSTRACT

A flavor strip retaining board for a vending machine signfront. The flavor strip retaining board has a mounting panel and a retaining panel that is spaced from and fastened to the mounting panel to receive flavor strips between the mounting panel and the retaining panel. Fasteners that fasten the mounting panel to the retaining panel are located to support and position flavor panels at a desired location on the mounting panel. The mounting panel may be mounted to a vending machine signfront panel or to a frame of the vending machine.

### RELATED APPLICATIONS

This application claims priority to U.S. Provisional Application Ser. No. 60/789,674, filed Apr. 5, 2006.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Vending machines, and particularly soft drink vending machines, attract customers with visually appealing graphics and images that identify and display the products that are sold by the machine. The front of a vending machine is the largest and most apparent surface that is viewed by customers and so is the surface on which the most appealing product graphics are located. Modern vending machines are constructed to accept a signfront mounted on the front of the vending machine which is typically also a door that opens to provide access to the interior of the machine for restocking and maintenance. The doors of vending machines are constructed to accept conventional mounting apparatus including T-bolts that extend from a signfront to mount the signfront to the door.

One type of vending machine signfront includes a section in which signs that depict or identify products sold by the machine are positioned. These signs, which are referred to as flavor strips, are conventionally sized so that several can be placed next to each other across the width of the signfront and so that rows of flavor strips are positioned on the signfront, typically near a customer's eye level. Signfronts that display flavor strips are constructed so that a flavor strip may be replaced to provide new graphics for the signfront and/or to display a different product when products sold by the machine are changed.

Signfronts that display flavor strips can be constructed in two sections, one section that supports the flavor strips, a flavor strip retaining board, and one section that is a cover or front panel that substantially covers the front of the vending machine door and includes one or more clear panels or windows through which the flavor strips are viewed from the front of the vending machine. The flavor strip retaining board and the front panel must be aligned with each other when mounted to a vending machine door to correctly position the flavor strips with respect to the front panel.

### BRIEF SUMMARY OF THE INVENTION

The present invention is a flavor strip retaining board for a vending machine signfront that is economic to manufacture and to assemble. A flavor strip retaining board according to the present invention supports one or more flavor strips, each flavor strip positioned adjacent to location on the vending machine front panel at which the flavor strip can be seen from the front of the vending machine. A mounting panel is sized to extend over the area adjacent to the signfront at which flavor strips are viewed from the front of the vending machine and a retaining panel is adjacent to the mounting panel to retain one or more flavor strips each adjacent to the front panel. Flavor strips are maintained at a desired location on the mounting panel by one or more positioning guides between the mounting panel and the retaining panel. Positioning guides may part of a fastener that fastens a retaining panel to a mounting panel or may be separate from a fastener. The mounting panel may be mounted adjacent to a vending machine signfront by being secured to the vending machine or to the front panel of the signfront.

In another aspect, the invention may also include tree clip fasteners for fastening the mounting panel to the front panel. These front panel tree clips include a shoulder that positions fastener within a hole in the front panel that resists movement of the tree clip in the front panel hole through which it passes and resists removal of the tree fastener clip from the front panel and the mounting panel.

In yet another aspect, the invention may also include tree clip fasteners for fastening a retaining panel to a mounting panel. These retaining panel tree clips have a head, a shoulder that extends front the head to a support surface and a tree portion that extends from the support surface. The shoulder is sized to extend through a hole in the mounting panel to position the support surface a distance from the mounting panel. The tree portion is sized to extend through a hole in the retaining panel that is smaller than the hole in the mounting panel through which the shoulder extends. The support surface of the retaining panel tree clip abuts the retaining panel and the tree portion of the mounting panel retaining clip holds the retaining panel against the support surface. The shoulder of the mounting panel tree clip may also be sized to function as a guide between the mounting panel and the retaining panel to position a flavor strip at a desired location.

The advantages of the present invention will be apparent from the embodiments described herein.

### BRIEF DESCRIPTION OF SEVERAL VIEWS OF THE DRAWINGS

FIG. 1 is a front view of a vending machine having an improved flavor strip retaining board according to the invention mounted adjacent to a signfront.

FIG. 2 is a top cross section view of the mounting of the signfront with improved flavor strip retaining board of FIG. 1 to the frame of the door of the vending machine.

FIG. 3 is a front view of the mounting panel of the improved flavor strip retaining board of FIG. 2.

FIG. 4 is a front view of two retaining panels of the improved flavor strip retaining board of FIG. 1.

FIG. 5 is a front and side view of a key hole clip that fastens the retaining panel of FIG. 4 to the mounting panel of FIG. 3.

FIG. 6 is a front view and side view of a washer that mounts to the key hole clip of FIG. 5.

FIG. 7 is a front view of a vending machine having another improved flavor strip retaining board according to the invention mounted to a signfront.

FIG. 8 is a rear view of the flavor strip retaining board of the signfront of FIG. 7.

FIG. 9 is a back view of the mounting panel of the flavor strip retaining board of FIG. 8.

FIG. 10 is a back view of a retaining panel of the flavor strip retaining board of FIG. 8.

FIG. 11 is an isometric view of a retaining panel tree clip that holds the retaining panel of FIG. 10 to the mounting panel of FIG. 9.

FIG. 12 is a side view of the retaining panel tree clip of FIG. 11.

FIG. 13 is view of another side of the retaining panel tree clip of FIG. 11.

FIG. 14 is an isometric view of a front panel tree clip that holds the mounting panel of FIG. 10 to the front panel of FIG. 7.

FIG. 15 is a side view of the retaining panel tree clip of FIG. 14.

FIG. 16 is view of another side of the retaining panel tree clip of FIG. 14.

### DETAILED DESCRIPTION OF THE INVENTION

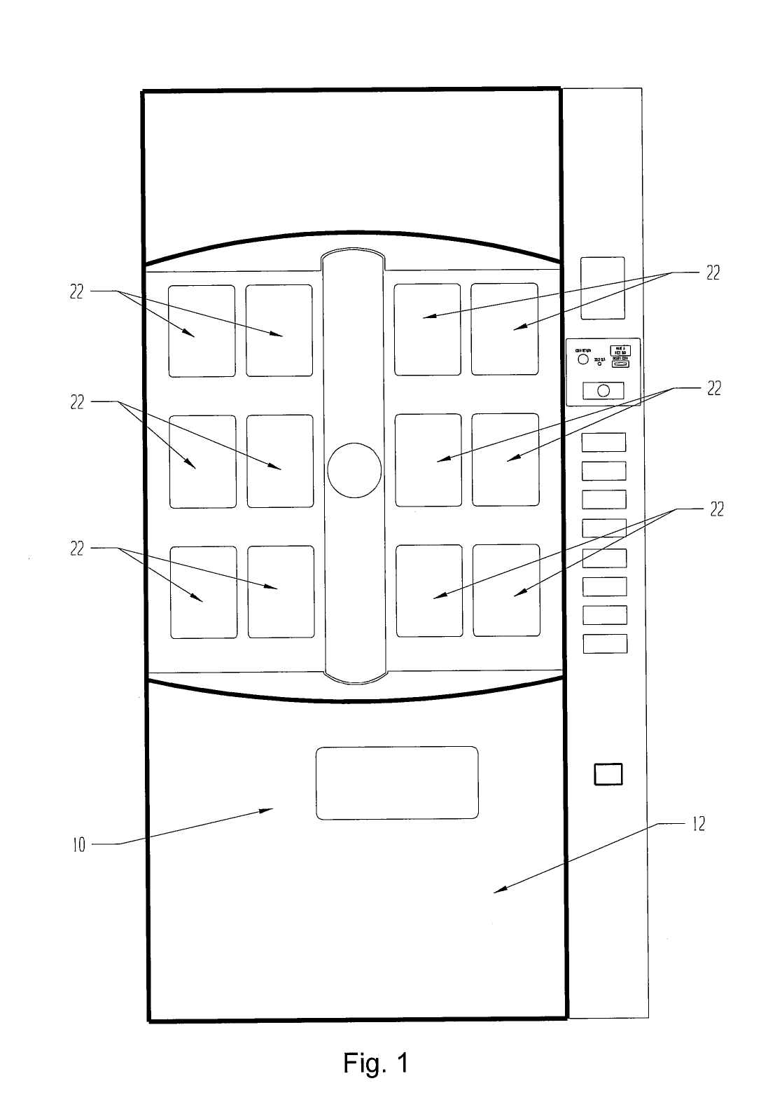

FIG. 1 shows a signfront 10 having a front panel 12 with clear sections through which flavor strips 22 are seen. The signfront 10 is mounted to the door of a vending machine.

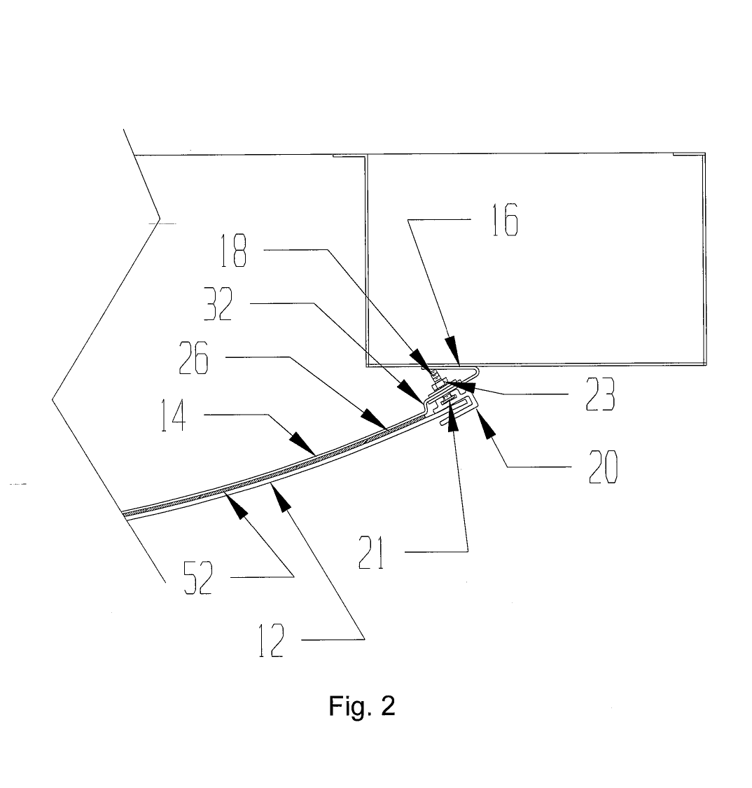

FIG. 2 shows a top cross section view of a portion of the front panel 12 and a flavor strip retaining board 14 secured to a vending machine door frame 16. As shown by FIG. 2, the flavor strip retaining board 14 is held to the frame 16 by T-bolts 18 that also hold a mounting guide 20 to the frame 16. The mounting guide 20 conventionally holds the front panel 12 within a slot.

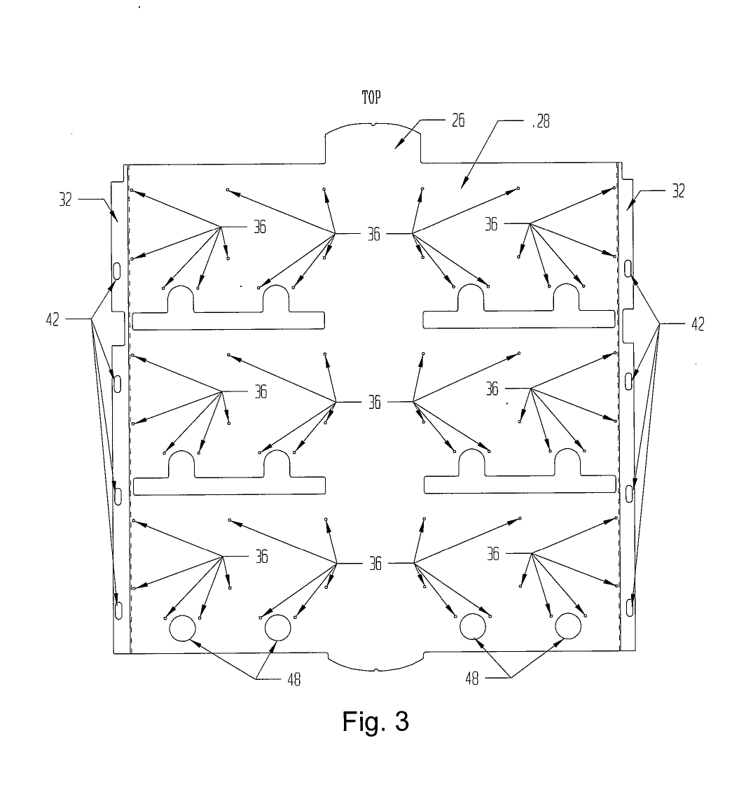

FIG. 3 shows a mounting panel 26 of the flavor strip retaining board 14 positioned as it would be mounted adjacent to the front panel 12. The mounting panel 26 has a middle flavor strip section 28 and a offset sections 32 at opposed sides of the flavor strip section 28. The flavor strip section 28 is sized to position the offset sections 32 adjacent to separated sections of the door frame 16. The mounting panel 26 is preferably 0.063 inches thick and is made of either polycarbonate or PETG. The mounting panel 26 is preferably clear or at least partially translucent so that light can pass to illuminate flavor strips. The mounting panel 26 is sufficiently flexible to conform to the front panel 12.

The flavor strip section 28 of the mounting panel 26 shown by FIG. 3 is sized to hold three rows of flavor strips 22, each row having four flavor strips 22. The mounting panel 26 has 60 holes 36 which are preferably 5/32″ diameter. The holes 36 are positioned to be at sides and below each location at which a flavor strip 22 is positioned on the flavor strip section 28. The flavor strip section 28 also has four slots 38 that extend generally horizontally. Two slots 38 are horizontally adjacent to each other between the upper and middle adjacent rows of the regions at which flavor strips 22 are positioned, and two slots 38 are horizontally adjacent to each other between the middle and lower rows of regions at which flavor strips 22 are positioned. The slots 38 each include two upwardly extending openings that each extend adjacent to a region at which a flavor strip is positioned above the slots 38. The flavor strip section 28 also includes four holes 48, each adjacent to the lowest part of the region at which a flavor strip 22 is positioned in the lower row. The slots 38 provide access through which flavor strips may be inserted from a back side of the flavor strip section 28 to be adjacent to regions below the slots 38 on a front side of the flavor strip section 28 at which flavor strips 22 are positioned. Flavor strips 22 may be positioned in the uppermost row of the flavor strip section 28 from above the flavor strip section 28. The upwardly extending sections of slots 38 and the holes 48 extend into the lower regions at which flavor strips are positioned to provide access through which flavor strips may be pushed upwardly to slots 38, in the case of the upper and middle row of flavor strips, or beyond the top of the flavor strip section 28 in the case of upper row of flavor strips so that flavor strips may be removed from the flavor strip retaining board 14.

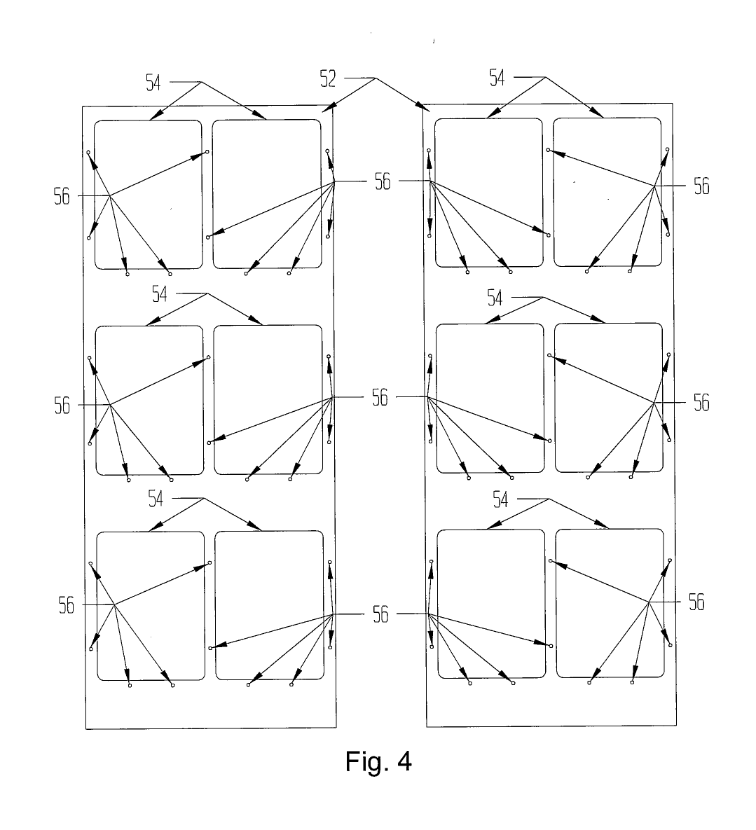

FIG. 4 shows two front retaining panels 52 of the flavor strip retaining board 14. The retaining panels 52 are sized to be positioned adjacent to each other overlying a portion of the flavor strip section 28. Each front retaining panel 52 defines six flavor strip openings 54 in three rows each having two openings 54. The openings 54 are sized to display the central portion of a flavor strip 22. Adjacent to each flavor strip opening 54 are holes 56 that are located to align with holes 36 in the flavor strip section 28 of the mounting panel 26. The front retaining panels 52 are preferably 0.031 inches thick and are made of either polycarbonate or PETG. The front retaining panels 52 are preferably sufficiently flexible to conform to the flavor strip section 28 and to the front panel 12.

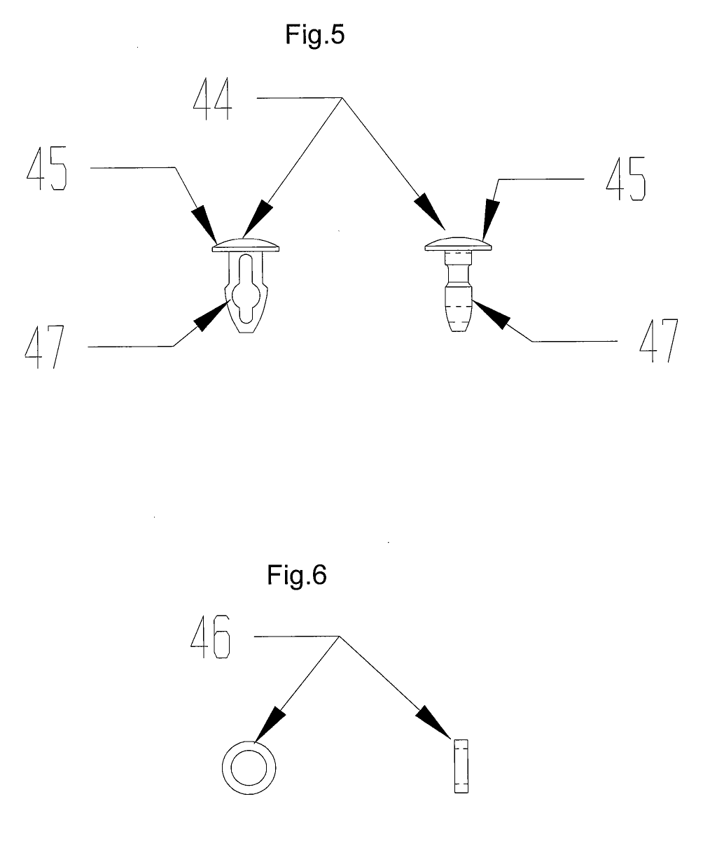

A key hole clip 44, as shown by FIG. 5, is inserted through each hole 56 from a front side of the front retaining panels panel 52 to abut a head 45 of the key hole clip 44 against the front side of the front retaining panel 52. A washer 46, as shown by FIG. 5, is positioned on a shaft 47 extending from the head 45 of each key hole clip 44 adjacent to a rear side of the front retaining panel 52. Each front retaining panel 52 is positioned so that flavor strip openings 54 are adjacent to locations on the flavor strip section 28 at which flavor strips 22 are positioned and so that key hole clip shafts 47 that extend through the front retaining panel 52 are aligned with holes 36 in the flavor strip section 28. The flavor strip retaining board 14 is assembled by urging the two front retaining panels 52 toward the flavor strip section 28 of the mounting panel 26 so that the key hole clip shafts 47 are pressed through the holes 36 to engage the mounting panel 26. The holes 36 and key hole clips 44 are sized to permit the shaft 47 of a key hole clip 44 to collapse sufficiently to be pressed through a hole 36 and to expand to engage the mounting panel 26. The key hole clips 44 extend through the front retaining panels 52, the washers 46 and the mounting panel 26 to retain the front retaining panels 52 against the washers 46 and the washers 46 against the mounting panel 26.

The washers 46 maintain a space between the flavor strip section 28 of the mounting panel 26 and the front retaining panel 52 so that a flavor strip 22 may be positioned between and retained by the mounting panel 26 and the front retaining panel 52. The key hole clips 44 and washers 46 are positioned so that they support and maintain the flavor strips 22 in their desired positions on the mounting panel 26. In this embodiment, flavor strips 22 are introduced between the retaining panels 52 and the flavor strip section 28 of the mounting panel 26 downwardly through the slots 38 in the mounting panel 26 and from the top of the mounting panel 26 in the case of the uppermost flavor strips.

Referring again to FIG. 3, the offset sections 32 at each side of the flavor strip section 28 of the mounting panel 26 each form a flange that is parallel to the flavor strip section 28 but is offset from that section a distance away from the front retaining board panels 52. Each offset section 32 defines four mounting slots 42 at separated locations along the height of the offset sections 32. The mounting slots 42 are sized and positioned so that they may positioned adjacent to openings for mounting hardware on conventional vending machine door frames as described below.

Referring again to FIG. 2, flavor strip retaining board 14 is positioned adjacent to the front panel 12 so that the retaining panels 52 are between the front panel 12 and the mounting panel 26. The offset sections 32 of the mounting panel 26 are positioned adjacent to separated upright sections of the frame 16. T-bolts 18 that extend from a slot 21 of a mounting rail 20 through the frame 16 and a mounting slot 42. A nut 23 engages a T-bolts 18 to secure the front panel 12 and the flavor strip retaining board 14 to the frame 16. The mounting slots 42 are elongated to allow the flavor strip retaining board 14 to be moved along the frame 16 and with respect to the front panel 12 to permit the flavor car retaining board 14 to be positioned at a desired location adjacent to the clear section of the front panel 12.

The flavor strip mounting board 14 is mounted to the frame 16 by the same T-bolts that secure the mounting rail 20 which retains the front panel 12 to the frame 16. The flavor strip mounting board 14 therefore requires no additional mounting structures or hardware. The front panel 12 and the flavor strip retaining board 14 may be mounted to a vending machine with conventional tools and without drilling holes or otherwise modifying a vending machine. There are no holes that extend through the front panel 12 so issues that can arise as a result of such holes are avoided by the front panel 12 and the flavor strip retaining board 14. Also because front panel 12 and the flavor strip retaining board 14 are mounted by conventional T-bolts, the front panel 12 and flavor strip retaining board 14 can be mounted to and removed from a vending machine without damaging them, and so they can be reused or moved from one vending machine to another.

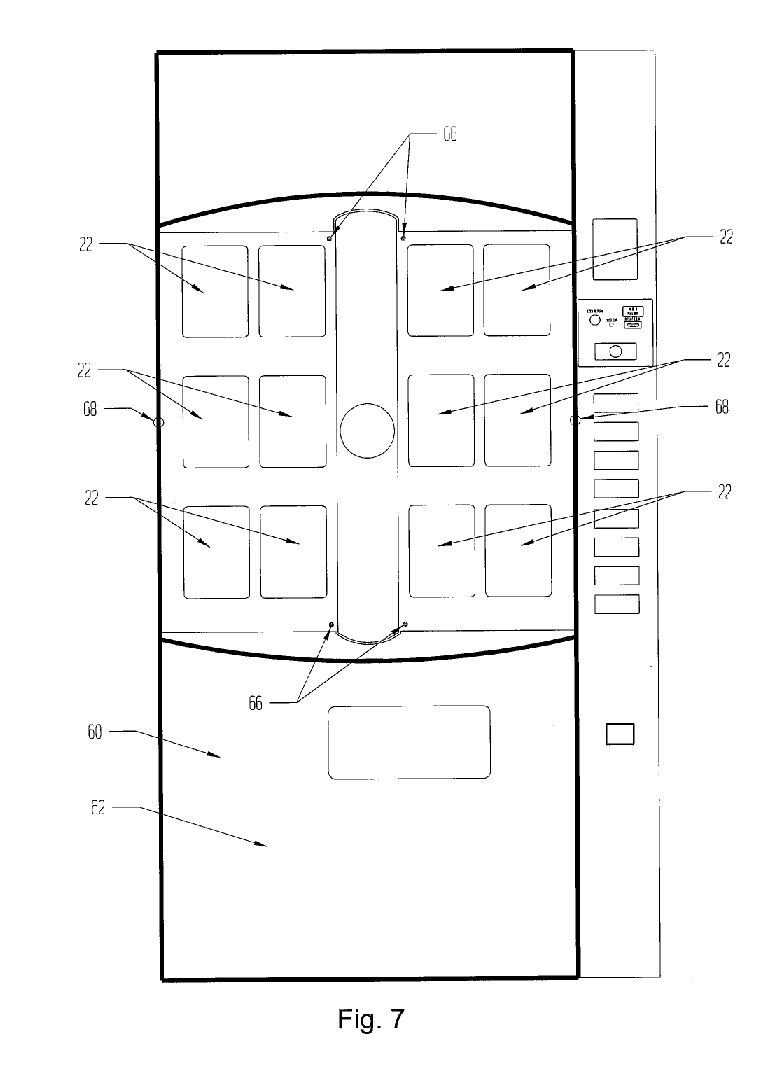

FIG. 7 shows a signfront 60 that has a front panel 62 with clear sections through which flavor strips 22 are seen. The signfront 60 is mounted to the door of the vending machine in a conventional manner. Retaining clips 66 and 68 extend through front retaining board panel 62 to secure a flavor strip retaining board according to another aspect of the invention (not shown) as described below.

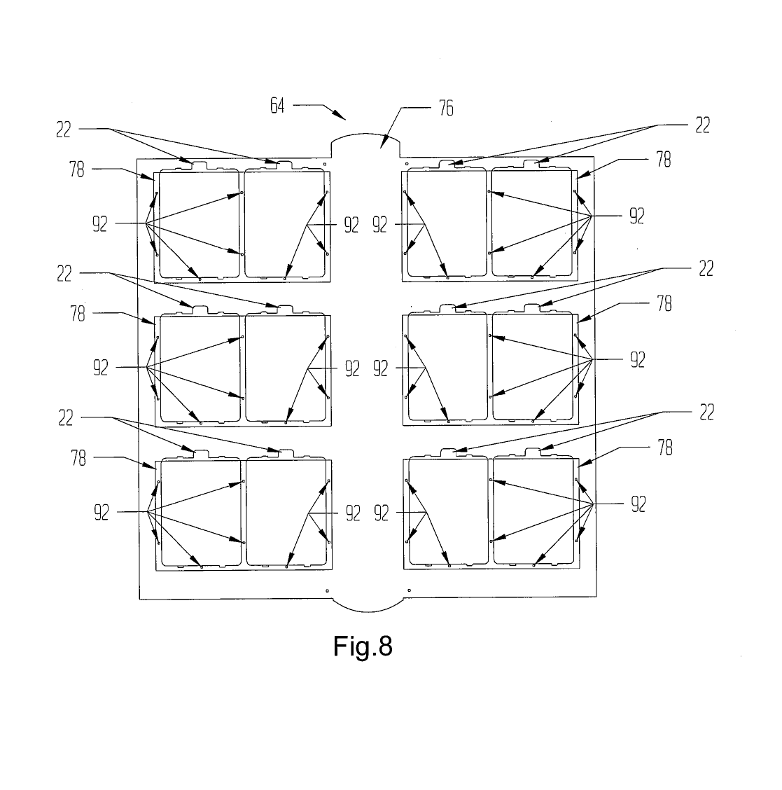

FIG. 8 is a rear view of a flavor strip retaining board 64 that is secured to the signfront 60. The flavor strip retaining board 64 is sized to extend over and beyond the area of the front panel 62 at which the flavor strips 22 are located. As described above by reference to flavor strip section 28 of the mounting panel 26, the flavor strips 22 are positioned by the flavor strip retaining board 64 in three rows of four flavor strips 22.

The flavor strip retaining board 64 has a mounting panel 76 that is positioned adjacent to the front panel 62 so that a front surface of the mounting panel 76 is adjacent to the front panel 62. The mounting panel 76 is preferably 0.031 inches thick and is made of either polycarbonate or PETG and is clear so that flavor strips can be seen through it. The mounting panel 76 is preferably sufficiently flexible to conform to the front panel 62 and is mounted to the front panel 62 by the front panel tree clips 66 and 68. Six retaining panels 78 are mounted in three rows of two retaining panels 78 to a rear surface of the mounting panel 76 that faces away from the front panel 62. Each retaining panel 78 is sized and secured to the mounting panel 76 by 8 retaining panel tree clips 92 (not all identified) as described below to hold two adjacent flavor strips 22.

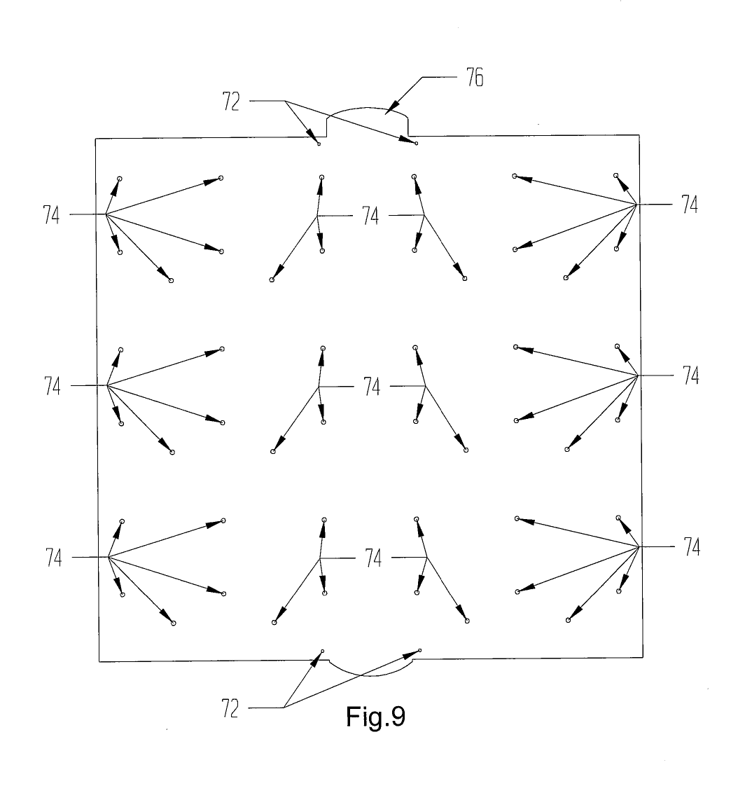

As shown by FIG. 9, the mounting panel 76 has four holes 72, two near the top of the mounting panel 76 and two near the bottom, through which the front panel tree clips 66 extend to mount the mounting panel 76 to the front panel 62. In this embodiment, the holes 72 are 0.170 inches in diameter. The mounting panel 76 also has forty eight holes 74 that are formed by three rows of two groups of eight holes each. Each row of groups of holes 74 is at a location at which a row of flavor strips 22 is located. In this embodiment, the holes 74 are 0.265 inches in diameter.

A retaining panel 78 is shown by FIG. 10. The retaining panels 78 are preferably 0.031 inches thick, made of either polycarbonate or PETG, and are at least partially translucent to allow light to pass through to illuminate a flavor strip 22. The retaining panels 78 are preferably sufficiently flexible to generally conform to the mounting panel 76 and to the front panel 62.

Each retaining panel 78 as shown by FIGS. 8 and 10 is generally rectangular and is positioned on the mounting panel 76 to have a pair of vertically extending sides and a pair of horizontally extending sides. The retaining panel 78 has three pairs of vertically separated pairs of holes 82. One pair of vertically separated holes 82 is positioned adjacent to each vertically extending side of the retaining panel 78 and one vertical pair of holes 82 is between those two pairs and generally equally distant from them. The vertical pairs of holes 82 are separated by a distance that will permit flavor strip 22 to be positioned between adjacent vertical pairs of holes 82. The retaining panel 78 has two holes 84 adjacent the lower edge of the pocket 78. The holes 84 are positioned approximately equal distances from the adjacent vertical pairs of holes 82. The holes 84 are separated from an upper edge of the retaining panel 78 so that a flavor strip 22 that is above the hole 84 will extend above the retaining panel 78 as shown by FIG. 8. The six holes 82 and two holes 84 on the retaining panel 78 align with a group of eight holes 74 in the mounting panel 76. In this embodiment, the holes 82 and 84 in the retaining panel 78 have a diameter of 0.170 inches.

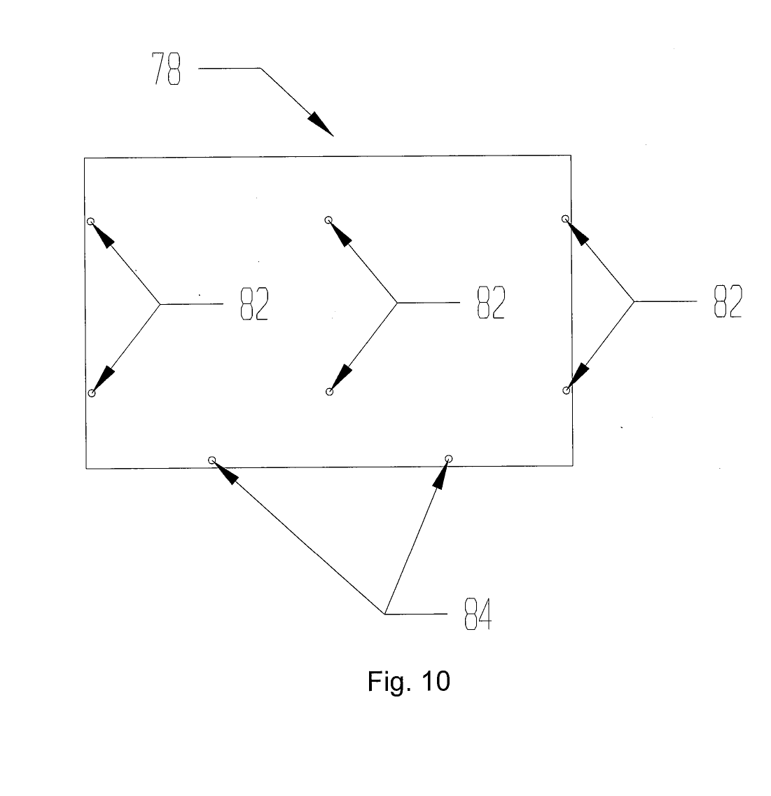

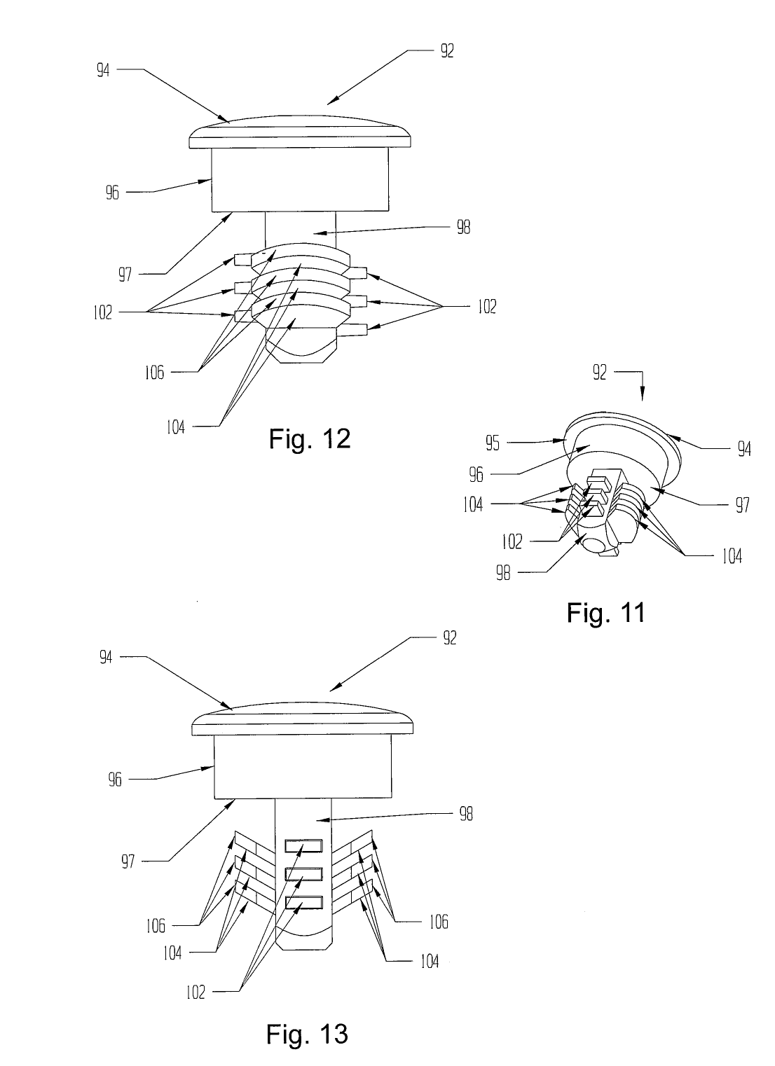

FIG. 11 shows retaining panel tree clip 92. Retaining panel tree clip 92 is a fastener that secures the retaining panels 78 to the mounting panel 76. The retaining panel tree clip 92 is preferably polycarbonate. The retaining panel tree clip 92 differs most significantly from conventional tree clips by the inclusion of a shoulder 96. The retaining panel tree clip 92 has a head 94 that is generally round, an outer diameter of approximately 0.312 inches and a thickness that varies from approximately 0.015 inches at its outer edge to approximately 0.045 inches at its center. The head 94 has a generally flat surface 95 near its outer diameter adjacent to a shoulder 96 that extends from the head 94. The shoulder 96 is generally round, concentric with and smaller in diameter than the head 94. The shoulder 96 extends from the head 94 along an axis that is approximately perpendicular to the surface 95 and extends through or near the center of the head 94. The shoulder 96 has a diameter of about 0.250 inches and extends along the perpendicular axis approximately 0.090 inches from the surface 95.

A retaining panel tree clip 92 is positioned within each of the holes 74 in the mounting panel 76 with the surfaces 95 of the heads 94 abutting an outer surface of the mounting panel 76 and the shoulders 96 extending through the mounting panel 76. The shoulder 96 forms a support surface 97 that is generally flat and parallel to the surface 95 and is separated from the surface 95 by approximately 0.090 inches. As disclosed above, the mounting panel 76 is approximately 0.031 inches thick. A retaining panel tree clip 92 that extends through the mounting panel 76 with its surface 95 abutting the outer surface of the retaining panel 76 will position the support surface 97 at a location that is separated from the mounting panel 76 by approximately 0.060 inches.

The retaining panel tree clip 92 has shaft 98 that extends from the support surface 97 generally along the axis along which the shoulder 96 extends. The shaft 98 has a generally rectangular cross section, two opposed sides having a width of approximately 0.080 inches and two opposed sides having a width of approximately 0.100 inches. The shaft 98 forms two pair of generally flat and parallel surfaces that extend from the shoulder 96.

Three generally flat tabs 102 extend from each of two opposed surfaces of the shaft 98 that are approximately 0.080 inches wide. The six tabs 102 each extend across a side of the shaft 98 generally perpendicular to the length of the shaft 98, and extend outwardly from the shaft 98 generally perpendicular to the axis along which the shaft 98 lies. As best shown by FIG. 12, the tabs 102 that extend from the opposed surfaces of the shaft 98 are staggered along the length of the shaft 98, positioned along the shaft 98 approximately midway between adjacent tabs of the opposed surface of shaft 98. The width of tabs 102 is preferably 0.050 inches, narrower than the surface of the shaft 98 from which they extend. The tabs 102 are preferably 0.015 inches thick, along the length of the shaft 98, and extend approximately 0.043 inches outwardly from the shaft 98. The tabs 102 are separated from adjacent tabs 102 by approximately 0.040 inches. The tab 102 that is positioned closest to the support surface 97 is approximately 0.06 inches from the support surface 97.

Three angled tabs 104 extend from each of two opposed surfaces of the shaft 98 that are approximately 0.100 inches wide. The angled tabs 104 extend across a side of the shaft 98 generally perpendicular to the length of the shat 98, and extend outwardly from the shaft 98 toward the head 94 and at an angle to the shaft 98. Preferably, the tabs 104 are at an angle of approximately 60° to the axis along which the shaft 98 extends. As best shown by FIG. 13, a tab 104 extends from each opposed surface of the shaft 98 at generally the same location along the length of the shaft 98. The tabs 104 form an outer surface 106 at their farthest extend from the shaft 98 that is generally circular about the axis along which the shaft 98 extends. Preferably, the diameter of the surfaces 106 is 0.194 inches. The tabs 104 are preferably 0.015 inches thick and are separated from adjacent tabs 104 by approximately 0.015 inches. The tabs 104 that are positioned closest to the head 94 extend toward the head 94 to locations that are approximately 0.045 inches from the support surface 97.

The flavor strip retaining board 64 is assembled by fastening each retaining panel 78 to the mounting panel 76 with eight retaining panel tree clips 92. Each retaining panel 78 is fastened to the mounting panel 76 by first positioning a retaining panel tree clip 92 through each of the eight holes 74 of the mounting panel 76 that comprise a group as described above and supporting the heads of those retaining panel tree clips 92. A retaining panel 78 is positioned adjacent to the mounting panel 76 so that the shafts 98 of the retaining panel tree clips extend to the holes 82 and 84 in the retaining panel 78. The retaining panel 78 is then urged toward the mounting panel 76 so that the shafts 98 and extending tabs 102 and 104 move through the holes 82 and 84 of the retaining panel 78 until the retaining panel 78 abuts the support surfaces 97 of the retaining panel tree clips 92.

As is conventional, urging the holes 82 and 84 of the retaining panel 78 over the tabs 102 and 104 will cause those tabs to deflect toward the shaft 98 as they move through the holes 82 and 84. The tabs 102 and 104 resiliently return to nearly their original configuration after they no longer contact the retaining panel 78. When the retaining panel 78 abuts the support surface 97 of a retaining panel tree clip 92, the tabs 102 and 104 closest to the support surface 97 extends outwardly from the shaft 98 to capture the retaining panel 78 between the support surface 97 and those tabs.

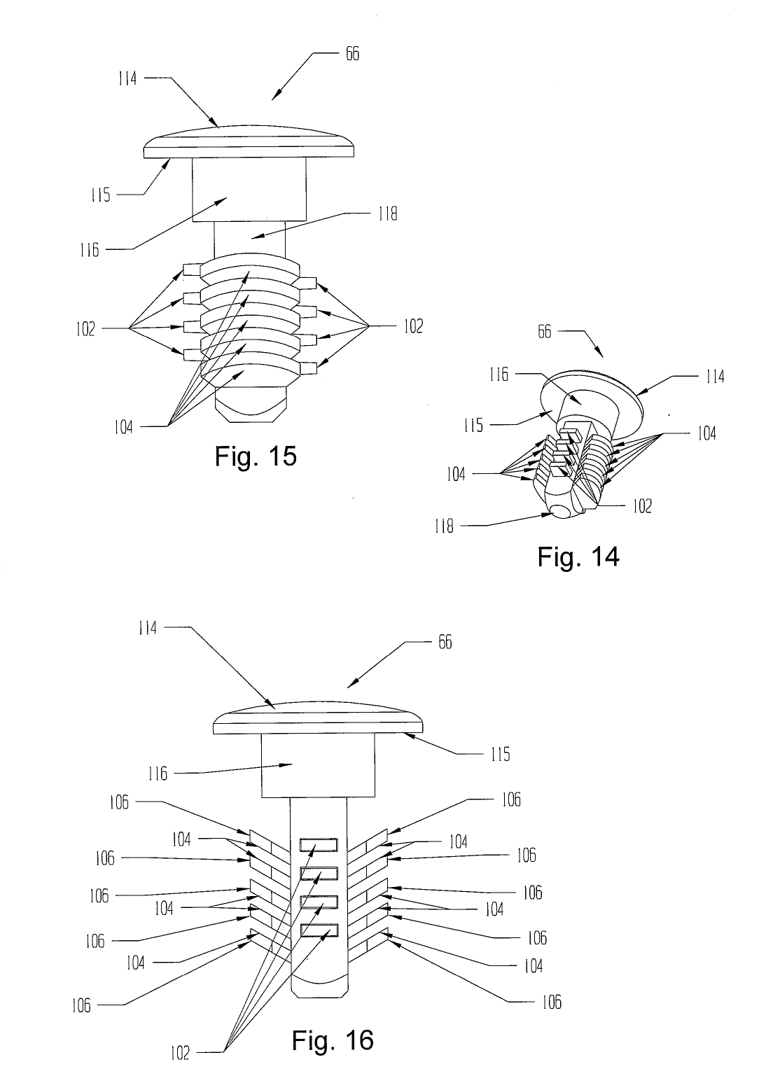

FIG. 14 shows a fastener that is referred to as front panel tree clip 66. Front panel tree clip 66 secures the mounting panel 76 to the front panel 62. The front panel tree clip 66 is preferably polycarbonate. The front panel tree clip 66 also differs most significantly from conventional tree clips by the inclusion of a shoulder 116. The front panel tree clip 66 has a head 114 that is generally round, has an outer diameter of approximately 0.295 inches and a thickness that varies from approximately 0.015 inches at its outer extent to approximately 0.045 inches at its center. The head 114 has a generally flat surface 115 near its outer diameter from which the shoulder 116 extends. The shoulder 116 is generally round, concentric with and smaller in diameter than the head 114. The shoulder 116 extends from the head 114 along an axis that is approximately perpendicular to the surface 115 and extends through or near the center of the head 114. The shoulder 116 has a diameter of about 0.160 inches and extends along the perpendicular axis approximately 0.090 inches from the surface 115.

As shown by FIG. 7, the front panel tree clips 66 extend through holes in the front panel 62 to position the head 114 of the front panel tree clip 66 against an outwardly facing surface of the front panel 62. The front panel 62 is approximately 0.115 inches thick and the holes through which the front panel tree clips 66 extend are preferably 0.166 inches in diameter. The shoulder 116 extends substantially through the front panel 62 and closely fits within the holes in the front panel 62 thereby substantially preventing the front panel tree clips 66 from rocking within the holes in the front panel 62 thereby providing a secure and tamper resistant connection to the front panel 62.

The front panel tree clip 66 has shaft 118 that extends from the shoulder 116 opposite the head 114 generally along the axis along which the shoulder 116 extends. The shaft 118 has a generally rectangular cross section, two opposed sides having a width of approximately 0.080 inches and two opposed sides having a width of approximately 0.100 inches. The shaft 118 forms two pair of generally flat and parallel surfaces that extend from the shoulder 116.

Like the retaining panel tree clips 92, the front panel tree clips 66 have generally flat tabs 102 that extend from two opposed surfaces of the shaft 118 that are approximately 0.080 inches wide. The front panel tree clip 66 has eight tabs 102, four that extend from each opposed surface of the shaft 118. The tabs 102 extend across a side of the shaft 118 generally perpendicular to the length of the shat 118, and extend outwardly from the shaft 118 generally perpendicular to the axis along which the shaft 118 lies. As best shown by FIG. 15, the tabs 102 that extend from the opposed surfaces of the shaft 98 are staggered along the length of the shaft 118, positioned along the shaft 118 approximately midway between adjacent tabs of the opposed surface of shaft 118. The width of tabs 102 is preferably 0.050 inches, narrower than the surface of the shaft 118 from which they extend. The tabs 102 are preferably 0.015 inches thick, along the length of the shaft 118, and extend approximately 0.043 inches outwardly from the shaft 118. The tabs 102 are separated from adjacent tabs 102 by approximately 0.040 inches. The tab 102 that is positioned closest to the head 114 is approximately 0.15 inches from the head 114.

Angled tabs 104 extend from two opposed surfaces of the shaft 118 that are approximately 0.100 inches wide. The angled tabs 104 extend across a side of the shaft 118 generally perpendicular to the length of the shaft 118, and extend outwardly from the shaft 118 at an angle toward the head 114. Preferably, the tabs 104 are at an angle to the axis along which the shaft 118 extends of approximately 60°. As best shown by FIG. 16, a tab 104 extends from each opposed surface of the shaft 118 at generally the same location along the length of the shaft 118. The tabs 104 form an outer surface 106 at their farthest extend from the shaft 118 that is generally circular about the axis along which the shaft 118 extends. Preferably, the diameter of the surfaces 106 is 0.194 inches. The tabs 104 are preferably 0.015 inches thick and are separated from adjacent tabs 104 by approximately 0.015 inches. The tabs 104 that are positioned closest to the head 94 extend toward the head 94 to locations that are approximately 0.135 inches from the head 94.

The flavor strip retaining board 64 is mounted to the front panel 62 by positioning the flavor strip retaining board 64 so that the surface of the mounting panel 76 against which the heads 94 of retaining panel tree clips 92 abut is adjacent to the front panel 62. The heads 94 of the retaining panel tree clips 92 are thereby captured between the front panel 62 and the mounting panel 76. The four holes 72 of the mounting panel 76 are aligned with holes in the front panel 62 that are located to position the flavor strip retaining board 64 so that flavor strips 22 are positioned adjacent to windows in the front panel 62. A shaft 118 of a front panel tree clip 66 is urged through each hole in the front panel 62 and through an aligned hole 72 in the mounting panel 76 front the outward facing surface side of the front panel 62 until the head 114 abuts the front panel 62.

The front panel 62 is 0.115 inches thick and the mounting panel 76 is 0.031 inches thick. When abutting each other, their total thickness is then 0.146 inches. As described above, the tab 102 that is closes to the surface 115 of the head 114 of the front panel tree clip 66 is separated from that surface by approximately 0.15 inches and the angled tabs 104 that are closes to the surface 115 extend to approximately 0.135 inches from that surface. As described above for retaining panel tree clips 92, urging the front panel tree clips 66 through the holes in the front panel 62 and holes 72 will cause the tabs 102 and 104 to deflect toward the shaft 118 as they move through the holes. Those tabs will resiliently return to nearly their original configuration after they no longer contact the mounting panel 76. Front panel tree clips 66 can be urged through the front panel 62 and mounting panel 76 so that the tabs 102 and 104 closest to the surface 115 extends outwardly from the shaft 118 to capture the mounting panel 76 and front panel 62 between the surface 115 and those tabs.

By holding the mounting panel 76 closely to the front panel 62, the heads 94 retaining panel tree clips 92 are forced against the mounting panel 76 and the retaining panels 78 that are adjacent to the support surfaces 97 of the retaining panel tree clips 92 are spaced from the mounting panel 76. The mounting panel 76 and the retaining panel 78 create pockets between then that are adjacent to the shoulders 116 of the retaining panel tree clips 92. The shoulders 96 of the retaining panel tree clips 92 support an align flavor strips 22 as did the washers in the first described embodiment. Among the advantages of the retaining panel tree clips 92 is the reduction in the number of parts required by the flavor strip retaining board.

The flavor strip retaining board 64 is also fastened to the front panel 62 by conventional tree clips 68 shown by FIG. 7. The mounting panel 76 extends across the width of the front panel 62 to extend into the mounting rail 20, as the front panel 12 is shown to do by FIG. 2. After the front panel 62 and the mounting panel 76 are positioned to extend into the mounting rail 20 along each vertical edge of the front panel 62 and the mounting panel 76, a hole is drilled through the mounting rail 20, the front panel 62 and the mounting panel 76 at each vertical edge approximately at approximately half the height of the front panel 62. The holes are drilled locations that are separated from mounting hardware such as the T-bolt 18. Preferably, the holes are one quarter inch in diameter. Tree clips 68 are conventional tree clips that are sized based on the diameter of the hole in which it is mounted and the length of the hole through the mounting rail 20. Capturing the mounting panel 76 in the mounting rail 20 against the front panel 62 and securing the mounting panel 76 and front panel 62 together with the mounting rail 20 by the tree clips 68 additionally secures the mounting panel 76 to the front panel 62.

The present invention has been described by reference to specific embodiments. It will be appreciated by those skilled in the art that the invention may be practiced other than as described. The invention is not be limited to the particular embodiments disclosed. What is sought to be protected is all embodiments falling within the scope of the appended claims.

We claim:

1. A flavor strip retaining board that supports one or more flavor strips adjacent to a front panel of a vending machine signfront within a vending machine, the flavor strip retaining board comprising:
a mounting panel sized to extend over an area of a front panel of a signfront through which flavor strips are visible,
a retaining panel sized to extend over an area of the mounting panel and positioned adjacent to the mounting panel,
a plurality of fasteners, each fastener extending through the mounting panel and through the retaining panel, the fasteners
each support a positioning guide in a space between the mounting panel and the retaining panel and
are located to support and locate a flavor strip between the mounting panel and the retaining panel at a flavor strip location on the mounting panel.

2. The flavor strip retaining board of claim 1 wherein the retaining panel is positioned between the mounting panel and the front panel of the signfront.

3. The flavor strip retaining board of claim 2 wherein the fasteners have a head and a shaft extending from the head,
the heads of the fasteners are positioned between the retaining panel and the front panel of the signfront and the shafts of the fasteners extend from the heads through the retaining panel and through the mounting panel, and
the positioning guides are washers that are positioned between the retaining panel and the mounting panel and through which the fastener shafts extend to support and position the positioning guide.

4. The flavor strip retaining board of claim 2 wherein the mounting panel is at least partially translucent and the retaining panel forms an opening adjacent to the flavor strip location.

5. The flavor strip retaining board of claim 2 wherein the mounting panel forms an opening adjacent to the flavor strip location, the opening is sized and positioned so that a flavor strip can be inserted through the opening into the space between the mounting panel and the retaining panel at the flavor strip location.

6. The flavor strip retaining board of claim 2 wherein the mounting panel forms a flange at each opposed edge of the front panel of the signfront at which the front panel is mounted to a frame of the vending machine, the flanges forming openings through which fasteners that mount the front panel to the frame of the vending machine extend through the mounting panel to engage and secure the mounting panel to the vending machine frame.

7. The flavor strip retaining board of claim 1 wherein the mounting panel is positioned between the retaining panel and the front panel of the signfront.

8. The flavor strip retaining board of claim 7 wherein the fasteners are tree clips that have a head, a shoulder extending from the head to form a support surface a distance from the head, a shaft extending from the support surface and a plurality of flexible tabs extending outwardly from the shaft from locations on the shaft that are separated from the support surface,
the heads of the fasteners are positioned between the mounting panel and the front panel abutting the front panel of the signfront and the shoulder of the fasteners extending through the mounting panel,
the retaining panel is adjacent to the support surfaces of the fastener shoulders,
the shafts extending from the support surfaces through holes in the retaining panel, and
one or more of the tabs extend from the shaft to a location adjacent to the retaining panel
whereby the fastener shoulders form the positioning guides and the retaining panel is captured between one or more of the tabs and the support surface of the fastener.

9. The flavor strip retaining board of claim 8 wherein the retaining panel is at least partially translucent and the mounting panel is clear.

10. The flavor strip retaining board of claim 7 wherein the front panel and the mounting panel form aligned mounting holes and the flavor strip retaining board further comprises
a front panel tree clip having a head, a shoulder extending a distance from the head, a shaft extending from the shoulder and a plurality of flexible tabs extending outwardly from the shaft from locations on the shaft that are separated from the shoulder,
the distance the shoulder extends from the head is substantially through the hole in the front panel,
the shoulder is sized to closely conform to that hole and
the shaft extends through the hole in the mounting panel the retaining panel
whereby movement of the front panel tree clip in the hole of the front panel is substantially prevented by the shoulder in the front panel and the mounting panel is captured between one or more of the tabs and the front panel.
